(19) United States
(12) Patent Application Publication
(10) Pub. No.: US 2011/0293081 A1
(43) Pub. Date: Dec. 1, 2011

(54) METHOD FOR PROVIDING TELEPHONE SERVICE USING THE INTERNET

(76) Inventors: Se Kyung Han, Gyeonggi-Do (KR); Seok Joo Ko, Gyeonggi-Do (KR)

(21) Appl. No.: 13/147,945

(22) PCT Filed: Jan. 11, 2010
(86) PCT No.: PCT/KR2010/000152

§ 371 Date: Aug. 4, 2011

(30) Foreign Application Priority Data
Feb. 5, 2009 (KR) 10-2009-0009489

(51) Int. Cl. H04M 15/00

(52) U.S. Cl. 379/114.1

(57) ABSTRACT

The method of the present invention comprises the steps of: outputting the content of the advertisement when the user clicks the advertisement and simultaneously providing the user with a telephone number input window for enabling the user to input the telephone number thereof and the telephone number of a person to be called; connecting a call between the user and the person to be called via a public switched telephone network regardless of whether or not the user has opted for membership when the telephone numbers are input to the input window and a request for connection is made; and enabling the user to talk to the person over the phone for free when the call connection is made in exchange for watching the advertisement.

### TECHNICAL FIELD

The present invention relates to a method for providing a telephone service using the Internet, and more particularly, to a method for providing a telephone service using the Internet, in which a free Internet call connection is made as a reward for only viewing a specific advertisement, and thus it is possible to achieve convenience of Internet telephone users, maximize advertising effects, and improve the service profit rate.

### BACKGROUND ART

In order to commercially use the Internet, diverse advertisements should be placed so that a plurality of

Internet users (hereinafter, referred to as “users”) may recognize details of the products or services of a company. It is most general that such an advertisement is placed on an Internet portal service site frequently used by the users or placed at a link list obtained through an Internet search.

Particularly, a link list shown at the top of a search page under the name of so-called “sponsor links” as a reward for paying a certain amount of money is displayed on a web page for displaying the link list obtained through the Internet search. The link list displayed in the “sponsor links” is a list confirmed above the other links when the user performs the Internet search, and since connection rates of the link list of corresponding sites are higher than those of a general link list, advertisers pay an amount aiming at considerable advertising effects.

From the viewpoint of an advertiser who has made a contract for displaying his or her website list in the “sponsor links”, since the advertiser has made the advertisement contract while expecting that a large number of users click his or her link list among a plurality of link lists and connect to his or her website, it is general that the contract is made in the form of a billing method called “overture” in which a click price is applied.

However, the link list described above, especially the “sponsor links”, is merely displayed at a certain position so that the users can confirm the sponsor links above the other links after performing a search, and a specific means for inducing user's connection is not provided separately. Therefore, there is an urgent need for a means for inducing user's connection from the viewpoints of advertisers. Such a need is an issue that should be solved in all types of advertisements using the Internet.

Meanwhile, Internet call connections are generally divided into a PC-to-PC method, a PC-to-phone method, and a phone-to-phone method. According to the PC-to-PC method, if an Internet protocol (IP) address of a callee, i.e., a called party is inputted after a piece of software related to the Internet phone is executed in a client system, a call connection to a callee's PC is established by an Internet phone server functioning as a central office in the Internet, and thus a phone call to the callee is allowed. The PC-to-phone method, which is an advanced model, connects a telephony gateway between the Internet and the PSTN so that a phone call can be made between a PC and a landline phone. In addition, the phone-to-phone method connects another type of telephony gateway between the Internet and the PSTN so that a phone call can be made between landline phones. Besides, as an advanced form of the call connection system described above, there is also proposed a technique capable of implementing a call connection system in which users can easily establish an Internet call connection by selecting a phone number recorded in a document displayed on a screen of a display device, such as a liquid crystal display, a monitor or the like, through a web browser, a document editor, or a document display window of an e-mail program.

Therefore, it has been attempted to actively induce user's connection by applying the call connection system in an advertisement project using the Internet. As an example of the attempt, Korean Patent Laid-open Publication No. 2002-29534 discloses a method for simultaneously providing a free phone call and an advertisement. Specifically, the method includes the steps of: receiving and registering a request of a user for joining as a member and an application of an advertisement company for registering advertisements; confirming whether or not a user is a valid member based on an ID and a password in response to a user's connection request and providing the user with a free phone call selection window; providing a banner advertisement list corresponding to information on the interests of the relevant member if the member selects a free phone call; and providing information on an advertisement and a free phone call window if the member selects the advertisement and allowing the member to select a counterpart and make a web phone call.

The free phone call described above can be accomplished by a connection structure of the web phone based on the Voice Over Internet Protocol (VOIP). If the user inputs a phone number of the counterpart through the free phone call window and requests a phone call, a service server senses the call request and transmits the call request into the Internet phone network to allow a call connection to be established.

### DISCLOSURE OF INVENTION

### Technical Problem

As described above, the link list on the web, especially “the sponsor links”, is merely displayed at a certain position so that a user can confirm the sponsor links above the other links after performing a search, and a specific means for inducing user's connection is not provided separately. In addition, due to the characteristics of billing types, the user may suffer damages from an access of a person having a malicious intent. From the viewpoints of advertisers, there occurs a problem in that advertising efficiency is lower compared to the fees paid for the advertisements.

In view of this aspect, the above-mentioned patent is of significance in that users are provided with Internet phone calls for free. However, in such a patent, a user should provide the service server with various kinds of his or her personal information and join as a member first of all in order to use the Internet phone calls for free. The reason for this is that a user should be identified because of the characteristic of the telephone service in which a caller, i.e., a calling party calls a specific counterpart. Accordingly, it is difficult for a user to freely and conveniently use the Internet phone call, and there is also a risk of leakage of the personal information. Furthermore, a user system needs means for making an Internet phone call based on the VoIP, such as a web phone, an execution program, and the like.

The present invention has been made to solve the above-mentioned problems associated with the prior art, and it is an object of the present invention to provide a method for providing a telephone service using the Internet, in which an Internet user connects to a service server and views an advertisement, and simultaneously the user can use a free Internet phone call as a reward for only viewing the advertisement without taking a prior action such as joining as a member or the like, thereby obviating inconvenience of the user and achieving high advertising efficiency.

### Technical Solution

A method for providing a telephone service according to the present invention includes: a first step of manufacturing an advertising page, gathering advertisers, displaying contents of an advertisement on the advertising page, storing the advertising page in a service server, and distributing a message indicating that a free phone call can be made, to a link list of an Internet site; a second step of outputting a list of stored advertisements or a free Internet phone call icon, together with the list of the stored advertisements, if a user connects to the advertising page by clicking the link list at the Internet site; a third step of outputting contents of the stored advertisement and, at the same time, providing a telephone information input window including phone numbers of the user and a counterpart, if the list or the icon is clicked; a fourth step of establishing a call connection between the user and the counterpart through a PSTN regardless of whether or not the user and the counterpart has joined as a member, if telephone information is inputted into the telephone information input window and the call connection is requested; and a fifth step of allowing the user to make a free phone call to the counterpart as a reward for viewing the advertisement, if the call connection is established.

The link list is a searched link list of an Internet site, a phone number displayed on a yellow page, or a banner or a tag of the Internet site. Preferably, the method for providing a telephone service further includes a sixth step of switching a current screen to an Internet site specified by a corresponding advertiser if the phone call of the fifth step is completed.

The advertisement list may be displayed such that a single advertisement list or a plurality of partitioned advertisement lists can be displayed on one advertising page. In addition, the advertisement list may be displayed such that advertisements of a single advertiser or a plurality of advertisers is displayed on one advertising page. Preferably, a message indicating that a free phone call can be provided as a reward for viewing an advertisement is displayed on a banner or a tag of a widget form at one side of the advertisement list.

In the meantime, in the model of the present invention, an amount of money is charged on each advertiser when the user clicks the link list, when the user clicks the advertisement list or the phone call icon, or when the user makes the free phone call, thereby making a profit.

### Advantageous Effects

In accordance with the present invention, a user's connection can be actively induced as the Internet phone service can be used for free, thereby obtaining high advertising effects. Furthermore, since a free phone call can be basically made as a reward for only viewing an advertisement without the need of inconvenient procedures such as joining as a member or the like, thereby eliminating inconvenience of the users. Therefore, phone call connections are increased further more, and further higher advertising efficiency can be obtained.

Meanwhile, since the service server simultaneously receives information on the phone numbers of a user and a counterpart and establishes a call connection between the user and the counterpart in a PSTN, it is advantageous in that a web phone, an execution program, and the like are not needed separately.

### BRIEF DESCRIPTION OF THE DRAWINGS

FIG. 1 is a block diagram showing a call connection system for performing services according to the present invention.

FIG. 2 is a block diagram showing a telephone service system according to the present invention.

FIG. 3 is a flowchart illustrating the procedure of providing a telephone service according to the present invention.

### BEST MODE FOR CARRYING OUT THE INVENTION

The above and other objects, features and advantages of the present invention will become apparent to those skilled in the art from the following description with reference to the accompanying drawings.

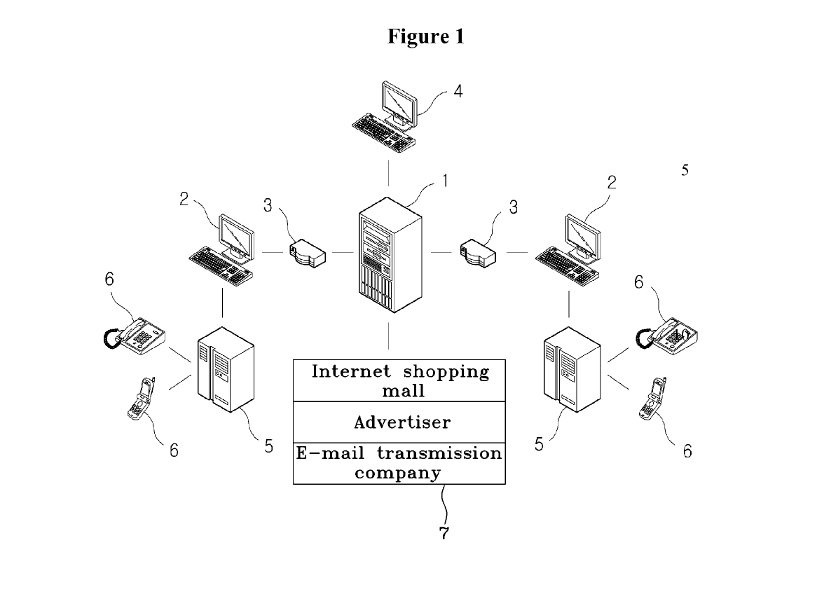

FIG. 1 is a block diagram showing a call connection system for performing a method for providing a telephone service according to the present invention.

Referring to the figure, the call connection system includes a service server 1 and user terminals 2 respectively connected to the service server 1 through the Internet. Although it is shown in FIG. 1 that the user terminals 2 are connectedly disposed only at both sides of the service server 1 for the sake of convenience of explanation, a quite large number of user terminals may be actually connected to the service server 1.

In this case, it is general that a router 3 is installed between the service server 1 and each of the user terminals 2 to connect the user terminals 2 to the service server 1 through the Internet, and reference numeral 4 represents a management terminal for managing the service server 1. In addition, the user terminal 2 is capable of connecting to an exchange 5 of a communication company in a corresponding region and making a phone call to a communication terminal such as a landline phone or a cellular phone 6. In the configuration described above, the service server 1 functions as a service server of an Internet website, which allows an Internet phone call between a user and a counterpart.

The service server 1 is connected to servers of other companies 7 including a website server of an Internet shopping company, a website server of an advertiser for placing Internet advertisements, a server of a separate e-mail transmission company, and the like and performs services in a variety of methods.

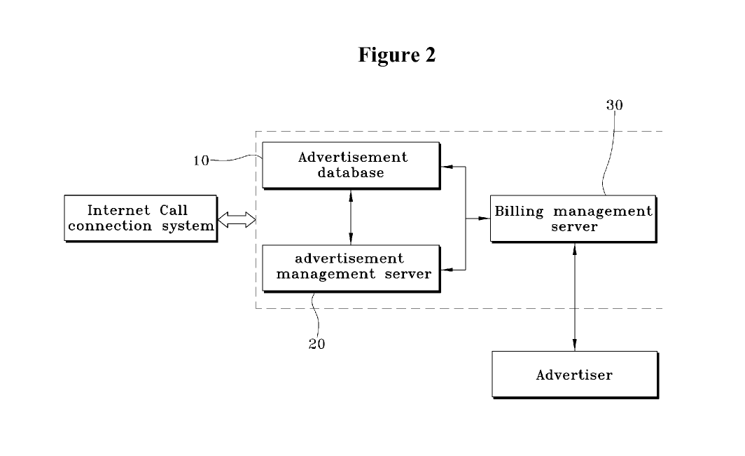

FIG. 2 is a block diagram showing a system for providing a telephone service using the call connection system described above. Referring to the figure, the telephone service system includes the call connection system described above, an advertisement database 10, an advertisement management server 20, and a billing management server 30.

The advertisement database 10 stores information on advertisers and data required for placing advertisements, such as moving pictures, images, sounds, and the like, in the form of an electronic file. Particularly, the advertisement database 10 stores and links data for showing a message, such as “making a free phone call” indicating that a free Internet phone call can be provided, at the link list displayed on a main page or a search page, in cooperation with the companies operating Internet portal search sites and the companies operating yellow pages.

The advertisement management server 20 operates the advertisement database 10 in order to manage and operate advertising pages on which an advertisement list of a single or a plurality of companies is displayed when a user clicks the link list and connects to the server. The billing management server 30 stores various kinds of billing information related to displaying the message at the link list and clicking a link, displaying an advertisement list and clicking an advertisement, and making an Internet phone call, and calculates an amount to be charged on the advertisers based on the billing information.

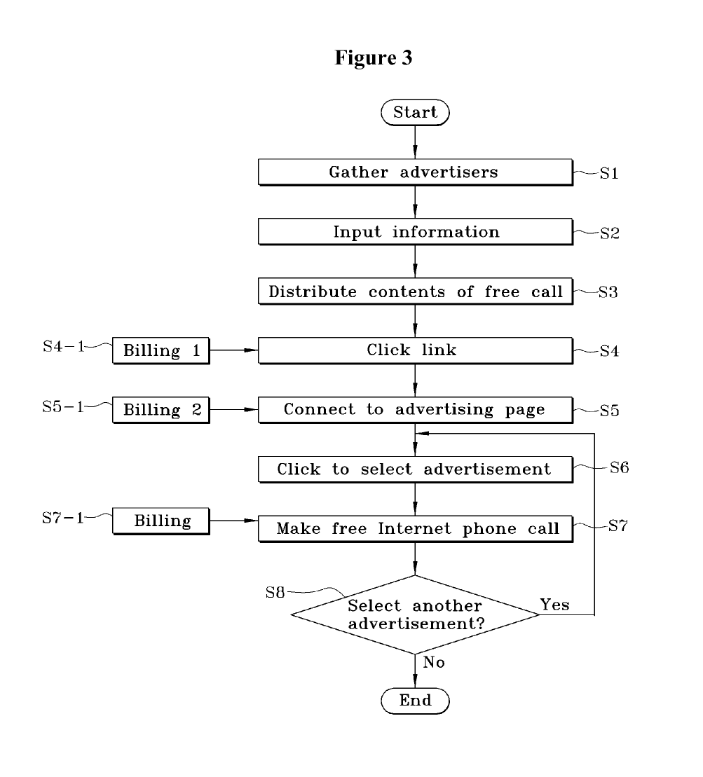

FIG. 3 is a flowchart illustrating the procedure of providing a telephone service according to the present invention. Referring to the figure, in order to perform the procedure of providing a telephone service according to the present invention, a website including advertising pages for placing advertisements is constructed, and advertisers are gathered Sl. If the advertisers are gathered, various kinds of information of the gathered advertisers are inputted into the advertisement database 10, and advertisement data such as moving pictures, images, sounds, and the like or contents of the advertisements requested by the advertisers are inputted and stored in the advertisement database 10 in the form of an electronic file S2.

Next, as a method for associating an advertisement with a free Internet phone call, a message indicating that a free phone call is provided as a reward for connecting to an advertisement site and viewing an advertisement is distributed to the link list of a main page or a search page of an Internet site operating company S3. This configuration is advantageous in that the free phone call service is rapidly recognized and users are persuaded to connect to the advertisement site within a short period of time. It is apparent that the users may connect to the website by themselves.

Herein, the Internet site operating company can be a portal site operating company, a yellow page operating company, an operator of a personal blog, or the like, and a sponsor link list of a portal site and hypertext-type phone numbers of a yellow page can be the most representative examples of the link list. Particularly, the message indicating that a free phone call is provided as a reward for connecting to an advertisement site and viewing an advertisement can be recorded on a banner or a tag of a widget form at one side of the advertisement list.

If the steps described above are completed and a user clicks the link list, the banner, or the tag displayed on a web page of an Internet site S4, the user can connect to an advertising page of the corresponding link list S5. At this time, the advertising page is an Internet site operated by the advertiser or a web page dedicated to advertisements.

In addition, the advertising page can be applied in a variety of embodiment forms, such as displaying an advertisement of an advertiser on an entire page screen, displaying advertisements of a plurality of advertisers in partitioned sections of a page, or displaying a plurality of advertisements of an advertiser in partitioned sections of a page. Preferably, a message indicating that a free phone call is provided as a reward for viewing an advertisement is displayed on a banner or a tag of a widget form at one side of the advertisement list.

As described above, an icon for making a free Internet phone call is displayed at one side of an advertisement screen, together with the contents of an advertisement, and if a user selects and clicks the advertisement or the phone call icon S7, the user can make a free Internet phone call as a reward for viewing the advertisement S8. In this case, the advertisement is displayed while the user uses the free Internet phone call.

Preferably, the phone call is allowed only for a predetermined period of time, such as 3 or 5 minutes, and it is configured such that if the phone call is terminated, the advertisement is stopped, and at the same time, a current site screen of the URL is switched to an Internet site specified by the advertiser, e.g., a home page of the advertiser. It is to meet the requirements of the advertisers requesting various exposures of the advertisement as a reward for providing the free phone calls.

In the steps described above, the free Internet phone call is performed by the Internet call connection system shown in FIG. 1, and at this time, a phone information input window for performing the free Internet phone call is provided at one side of the screen on which contents of the advertisement are displayed. As shown in the figure, the phone information input window is configured to input telephone information including the phone numbers of the user and the counterpart at the top and bottom portions.

In this manner, the service server 1 simultaneously receives the information on the phone numbers of the user and the counterpart and establishes a call connection between the user and the counterpart through the PSTN. At this time, the service server 1 has an algorithm specially designed in order not to confirm whether or not the user or the counterpart is a member. On the other hand, since a cellular phone and a landline phone are used as communication means, a web phone and an execution program are not needed separately.

If the user desires to extendedly use the free Internet phone call after the free Internet phone call is terminated, the user should select and click a different or the same advertisement or the free Internet phone call icon. This can be inconvenient from the viewpoint the user. Accordingly, it is inquired whether or not to select and view an advertisement again while the user uses the free Internet phone call S8, and if the user selects and clicks an advertisement or the icon again in response to the inquiry, the free Internet phone call is extended, and the user can view the selected advertisement without fail. Herein, although it is described that the free Internet phone call is basically provided as a reward for only viewing an advertisement without the procedure of joining as a member or the like, if a website including an advertisement page dedicated to the advertisement is operated as an Internet site, the free Internet phone call may be provided as a reward on a condition that requirements such as joining as a member or inputting user information are fulfilled. However, this is not necessarily required technologically.

Meanwhile, in order to beneficially create profit structure of a telephone service providing company in the steps described above, telephone bills are settled by the billing management server 30 and charged on the advertiser when the user clicks the link list, when an advertising page is displayed and a user clicks an advertisement, and when the user make a free Internet phone call as a reward for viewing the advertisement S4-1, S5-1, and S6-1.

1. A method for providing a telephone service using the Internet, the method comprising:
a first step of storing an advertising page which displays contents of an advertisement in a service server;
a second step of outputting a link list of stored advertisements if a user connects to the advertising page of the service server through the Internet;
a third step of providing a telephone information input window for inputting phone numbers of the user and a counterpart;
a fourth step of establishing a call connection between a user's communication terminal and a counterpart's communication terminal through the Internet by the service server connected between an exchange of a communication company connected to the communication terminal of the user corresponding to the user's phone number and an exchange of a communication company connected to the communication terminal of the counterpart corresponding to the counterpart's phone number, if the phone numbers of the user and the counterpart are inputted into the telephone information input window and the call connection is requested; and
a fifth step of allowing the user to make a free phone call to the communication terminal of the counterpart through the service server using the communication terminal of the user as a reward for viewing the advertisement if the call connection is established.

2. The method according to claim 1, wherein the link list is a searched link list of an Internet site, a phone number displayed on a yellow page, or a banner or a tag of the Internet site.

3. The method according to claim 1, further comprising a sixth step of stopping the advertisement and simultaneously switching a screen to an Internet site specified by a corresponding advertiser if the phone call of the fifth step is completed.

4. The method according to claim 1, further comprising the step of outputting an inquiry, while using the free phone call, for asking whether or not to select and view an advertisement again to meet a need of the user for extending and using the free phone call further longer, and allowing the user to extend the free phone call and view the advertisement selected again depending on a response of the user.

5. The method according to claims 1, wherein the free phone call is terminated when a predetermined time period has elapsed, and the relevant advertisement is stopped and a current screen is switched to an Internet site specified by the advertiser when the free phone call is terminated.

6. The method according to claim 1, wherein the link list of the advertisement is displayed such that a link list of a single advertisement or a plurality of partitioned advertisements is displayed on one advertising page.

7. The method according to claim 1, wherein the link list of the advertisement is displayed such that advertisements of a single advertiser or a plurality of advertisers are displayed on one advertising page.

8. The method according to claim 1, wherein a message indicating that a free phone call is provided as a reward for viewing an advertisement is displayed on a banner or a tag of a widget form at one side of the link list of the advertisement.

9. The method according to claim 1, wherein an amount is charged on each advertiser when the user selects a link corresponding to the link list of the advertisement and when the user makes the free phone call.
